(19) United States
(12) Patent Application Publication
(10) Pub. No.: US 2026/0206117 A1
(43) Pub. Date: Jul. 16, 2026

(54) Emergency Flashing Light Device

(71) Applicant: Jasco Products Company LLC, Oklahoma City, OK (US)

(72) Inventors: Matt Henson, Oklahoma city, OK (US); Craig Morris, Oklahoma City, OK (US); Mitchell Davis, Oklahoma City, OK (US); Josh Roberson, Oklahoma City, OK (US); Mark Simpkins, Oklahoma City, OK (US)

(21) Appl. No.: 19/021,367

(22) Filed: Jan. 15, 2025

(51) Int. Cl. H05B 47/17; G08B 5/38; G08B 17/10; G08B 25/12; H05B 45/20; H05B 47/115; H05B 47/16; H05B 47/175; H05B 47/19

(52) U.S. Cl. CPC H05B 47/172; G08B 5/38; G08B 17/10; G08B 25/12; H05B 45/20; H05B 47/115; H05B 47/16; H05B 47/19; H05B 47/1965

(57) ABSTRACT

The present invention pertains to a device which communicates a flash sequence to an attached load. More specifically, the invention pertains to an in-wall device which activates an emergency visual alert flashing sequence that continuously cycles until deactivated. Embodiments described for the present invention comprise a housing, a line, a load, a neutral, a power converter, a timing and control circuit, a switching mechanism, an on button, an on switch, an off button, an off switch, an emergency sequence activator button, an emergency sequence activator switch, whereas the emergency sequence activator switch closes when the emergency sequence activator button is pressed, and the timing and control circuit applies an alternating signal to the switching mechanism which alternately closes and opens a connection between the line and the load which supplies and removes power to the at least one electrically connected lighting device in response to the alternating signal.

### BACKGROUND OF THE INVENTION

### 1. Field of the Invention

The present invention pertains to a device which communicates a flash sequence to an attached load. More specifically, the invention pertains to an in-wall device which activates an emergency visual alert flashing sequence that continuously cycles until deactivated.

### 2. Description of the Related Art

During an emergency at a residence, the swift and accurate response of police, firefighters, and ambulance personnel is critical, as every second can significantly impact the outcome. In some cases, emergency responders might mistakenly arrive at the wrong address, losing precious moments in the process. Recognizing the urgency, individuals present at the scene may attempt to guide the responders to the correct location, potentially mitigating the impact of any delays. However, there are also scenarios where individuals are unable to assist in this way, underscoring the importance of clear communication and precise information to ensure that help arrives as quickly as possible.

U.S. Pat. No. 9,689,542 discloses a system and method that helps evacuees exit a residential structure in the event of an emergency such as a fire, earthquake, security breach or the like, by providing emergency illumination around the periphery of an exit door or an alternative safe exit portal together with floor or ground level illumination along the path to the portal, and by providing an audible tone or voice recording to guide occupants to the exit portal.

U.S. patent application 2019/0013960 discloses a wireless control system which includes multiple wireless transmitters and a control circuit configured to transmit information from the wireless transmitters, wherein the control circuit is configured to enable and disable each of the wireless transmitters.

### SUMMARY OF THE INVENTION

The present invention comprises an advanced safety structure designed for both in-wall and plug-in devices, accessible via a Wi-Fi app or a physical button press. The device activates a distinctive flashing sequence on the attached load, initiating a three-flash pattern followed by a pause, and then repeating the cycle continuously until deactivated. The feature can be triggered either through a non-Wi-Fi button press, the Wi-Fi app for wireless control, or directly from the device's front panel, comprised of both toggle and rocker switch versions.

The device is also compatible with non-Wi-Fi devices. Its primary purpose is to create a conspicuous visual alert that can attract attention from neighbors, a passersby, or medical personnel, facilitating quick recognition and response in emergency situations.

Embodiments described for the present invention comprise a housing, a line, a load, a neutral, a power converter, a timing and control circuit, a switching mechanism, an on button, an on switch, whereas the on switch closes when the on button is pressed, and the timing and control circuit is configured to apply a signal of correct state to activate the switching mechanism and close a circuit between the line and the load which supplies power to at least one electrically connected lighting device, an off button, an off switch, whereas the off switch closes when the off button is pressed, and the timing and control circuit is configured to apply a signal of correct state to deactivate the switching mechanism and open the circuit between the line and the load which removes power to at least one electrically connected lighting device, an emergency sequence activator button, an emergency sequence activator switch, whereas the emergency sequence activator switch closes when the emergency sequence activator button is pressed, and the timing and control circuit is configured to apply an alternating signal to the switching mechanism which alternately closes and opens a connection between the line and the load which supplies and removes power to the at least one electrically connected lighting device in response to the alternating signal.

In alternate embodiments, when the emergency sequence activator switch is closed, the timing and control circuit is configured to apply a continuous alternating signal to the switching mechanism which alternately closes and opens a connection between the line and the load which supplies and removes power to the at least one electrically connected lighting device in response to the alternating signal when the on switch is in a closed or open position or when the off switch is in a closed or open position.

Embodiments include whereas the emergency sequence activator switch closes when the emergency sequence activator button is pressed, and the timing and control circuit is configured to apply an alternating signal with a prescribed sequence and a prescribed repetition to the switching mechanism. Embodiments may also include sensors, color change features, communication with a wireless network, bulbs, and in-wall devices without an emergency sequence activator button.

It should be appreciated that combinations of the foregoing concepts and additional concepts discussed in greater detail below are contemplated as being part of the inventive subject matter disclosed herein. In particular, all combinations of claimed subject matter appearing at the end of this disclosure, or elsewhere herein, are contemplated as being part of the inventive subject matter.

These and other systems, methods, objects, features, and advantages of the present invention will be apparent to those skilled in the art from the following detailed description of the preferred embodiment and the drawings.

### BRIEF DESCRIPTION OF THE DRAWINGS

One or more embodiments are illustrated by way of example, and not by limitation, reference will now be made to the accompanying drawings, having the same numeral designations to represent like elements throughout and wherein:

FIG. 1 shows a block diagram of an embodiment of a device;

FIG. 2 shows a front elevational view of the embodiment of the device;

FIG. 3 shows a block diagram of an embodiment of the device;

FIG. 4 shows a block diagram of an embodiment of the device;

FIG. 5 shows a front elevational view of an embodiment of the device;

FIG. 6 shows a front elevational view of an embodiment of the device;

FIG. 7 shows a front elevational view of an embodiment of the device;

FIG. 8 shows a front elevational view of an embodiment of the device;

FIG. 9 shows a front elevational view of an embodiment of the device;

FIG. 10 shows a front elevational view of an embodiment of the device; and

FIG. 11 shows a front elevational view of an embodiment of the device.

While the invention has been described in connection with certain preferred embodiments, other embodiments would be understood by one of ordinary skill in the art and are encompassed herein. Elements with corresponding reference numerals:
Emergency flash device 100
Housing 2
Line 4
Load 6
Neutral 8
Power converter 10
Timing and control circuit 12
Switching mechanism 14
On button 16
On switch 18
Off button 20
Off switch 22
Emergency sequence activator button 24
Emergency sequence activator switch 26
Sensor 28
Smart phone 30
Laptop 34
Remote 36
Bulb 38
Wireless receiver/transceiver 40
Networking Hub or WiFi Router 42
Smart Switch 44
Smart Dimmer 46
Smart phone app activator button 48
Emergency services 50
Voice detect device 52

### DETAIL DESCRIPTION OF THE INVENTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in order to facilitate describing the subject innovation. Moreover, it is to be appreciated that the drawings may not be to scale.

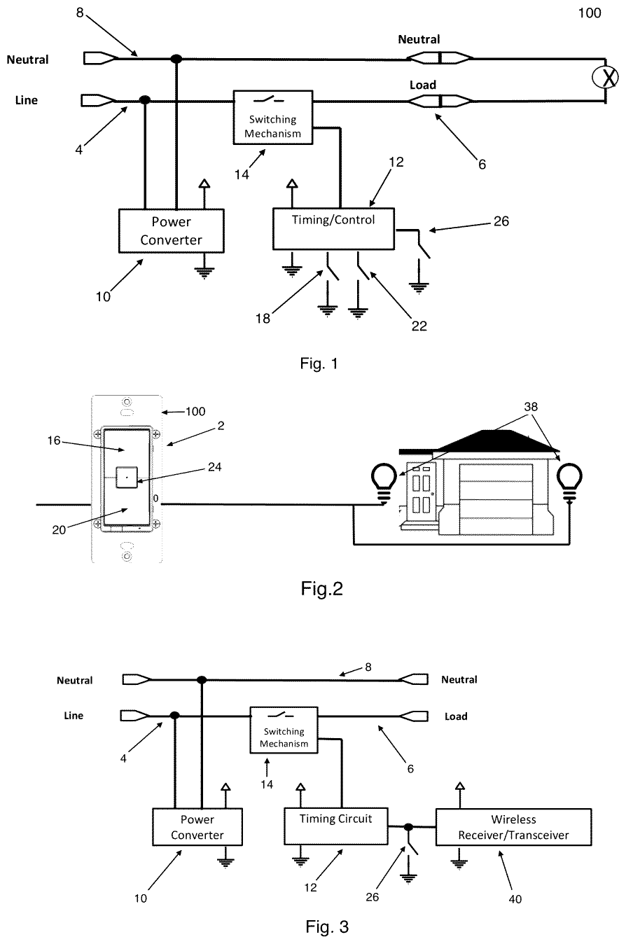

FIG. 1 shows a block diagram of an embodiment of a device. The device is comprised of a housing 2, electrical connections for a line 4, neutral 8, and load 6 wiring, a power converter 10, a timing and control circuit 12 electrically connected to a switching mechanism 14, an emergency sequence activator switch 26, an on switch 18, and an off switch 22.

In normal operation, the device may be installed in a standard US electrical gang box (not shown), providing connection to a single phase AC power via connectors line 4, neutral 8, and load 6. The line voltage is delivered to one side of the switching mechanism 14. The switching mechanism may be an electromechanical relay or a triac. The output of the switching mechanism 14 is connected to the load terminal which will power a connected load.

The state of the switching mechanism 14 is controlled by the on switch 18, off switch 22, and the emergency sequence activator switch 26 via the timing and control block circuit 12. When power is applied to the line and neutral connectors, the power converter supplies a potential to the timing and control circuit and switching mechanism enabling operation.

When an on button 16 (not shown) is pressed, the on switch closes 18, and the control circuit applies a signal of correct state to activate the switching mechanism and close the circuit between the line and load turning on a connected light. When an off button 20 (not shown) is pressed, the off switch 22 closes, and the timing and control circuit applies a signal of correct state to deactivate the switching mechanism and open the circuit between the line and load removing power to the connected light.

When the emergency sequence activator button 24 (not shown) is pressed, the emergency sequence activator switch 26 closes, and the timing and control circuit applies the alternating signal to the switching mechanism 14 that alternately closes and opens the connection between the line and load terminal thereby turning the light on and off following the alternating signal. While the switch 26 is active, the on switch 18 and off switch 22 states may be ignored until the flash sequence is stopped by pressing the button 24 a second time.

FIG. 2 shows a front elevational view of the embodiment of the device. In this embodiment, the device is comprised of an emergency sequence activator switch (not shown). Under normal operation, an on button 16 turns the load on and an off button 20 turns the load off. Regardless of a present state of the switch, when the emergency sequence activator switch 26 (not shown) is activated via the emergency sequence activator button 24, the switch powers the connected lighting devices 38 on and off in a predetermined pattern signifying an emergency or state of need exists in the home.

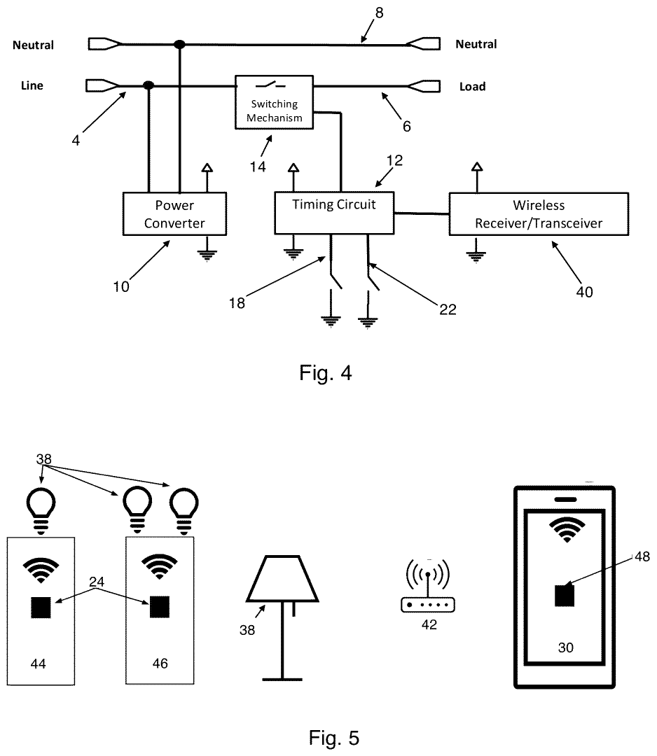

FIG. 3 and FIG. 4 show block diagrams of embodiments of the device. In these embodiments, the device is comprised of a wireless receiver/transceiver 40. The device may be connected to a networking hub or Wi-Fi Router (not shown). Theses embodiments may be comprised of an emergency sequence activator switch 26 and/or an on switch 18 and an off switch 22.

FIG. 5 illustrates an embodiment connected to a hub or wireless network 42. An emergency sequence may be activated by a smart phone 30 app or from any connected device, all devices with the emergency flash enabled will flash connected lighting devices at the specified flash pattern, rate, and color to signify there is an emergency. The network may be Wi-Fi, Zigbee, or any wireless system. The lighting device may be a smart bulb 38. Some embodiments will be comprised of a sensor 28, whereas the sensors can be incorporated for positional changes to alert the system. The sensors may detect: water leak, air quality, radon, smoke, door or window positional changes, or motion. The emergency sequence activator switch may be closed by commands received from one of the following: a smart phone 30, a personal computer or laptop 34, or a wireless remote 36. Any sensors, known to those having ordinary skill in the art, which may communicate through a wireless network are within this disclosure.

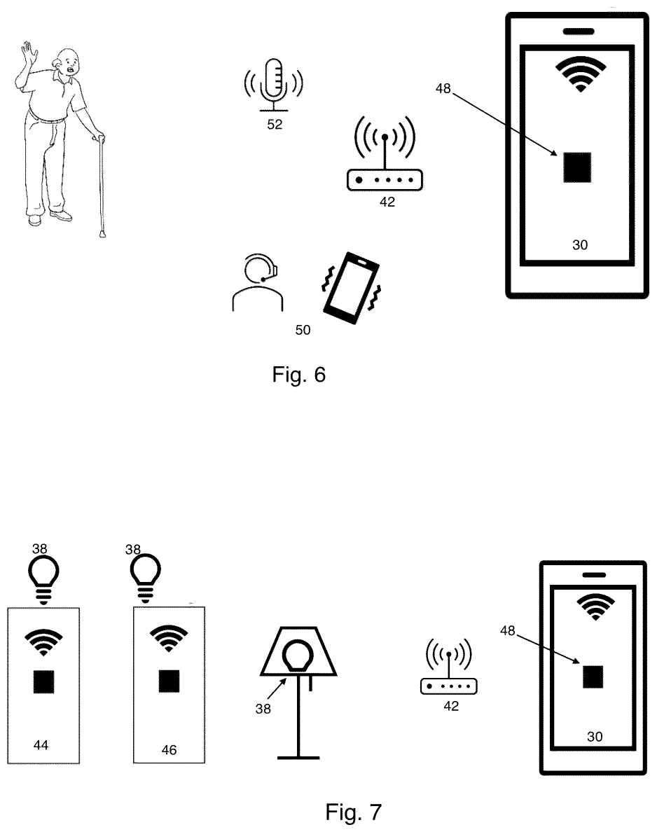

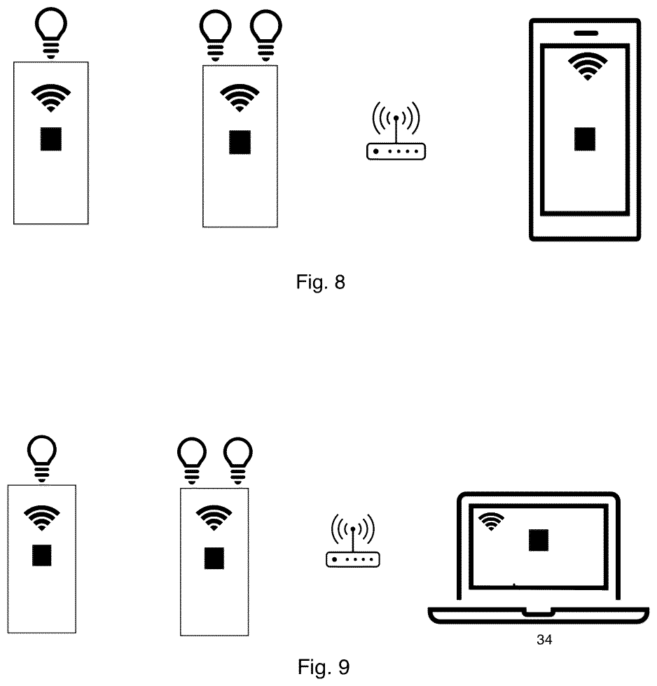

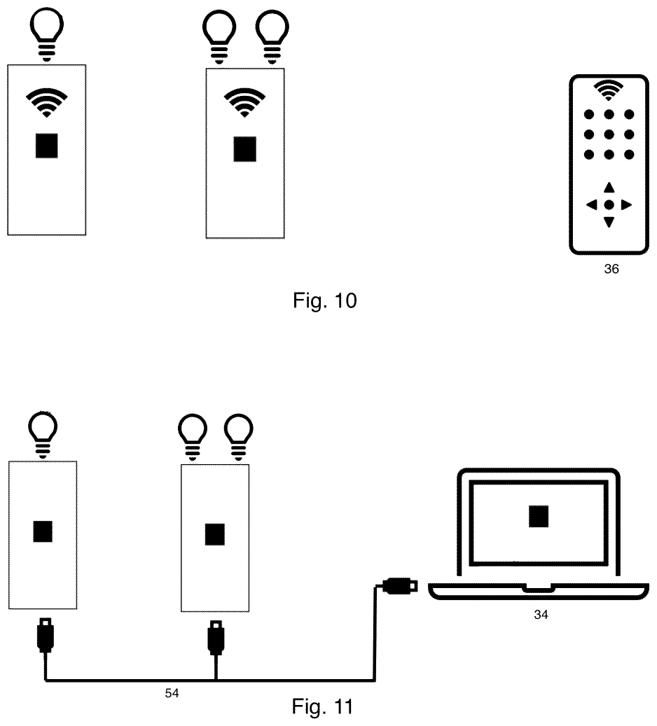

FIG. 6 illustrates an embodiment where once the emergency flash sequence is activated, emergency services 50 receive a push notification or any other emergency notification. The device may further include any electrically connected or wirelessly connected voice detect device, which may activate the emergency flash sequence. FIG. 7 illustrates an embodiment comprised of a smart switch 44, a smart dimmer 46, a smart phone app activator button 48, a wireless network 42, and multiple bulbs 38.

Embodiments include relay switch configuration options. The switch configuration options may be controlled through an app. The device may include different modes, including: standard mode, smart bulb mode, and tamper mode. In standard mode, the device power follows app status and the manual switch control is fully functional. The relay may be turned on and off with a rocker switch or toggle front panel, app or voice control. For smart bulb mode, the device power is always on, the manual switch control is disabled, and the smart bulb is controlled by an app. The connected load receives continuous power. For tamper mode, the device power is always off, and the manual switch is disabled. Iterations include where one or more single tap buttons are active only when the tamper mode is selected. When the mode is off, single tap scene activation buttons are inactive.

App controlled embodiments of the emergency load flash feature provide enhanced control. A user can exit the app screen to operate other devices. The flash sequence continues until stopped. A connected light will flash three times, pause, then repeat. The switch power is always on. The manual switch control is disabled. Schedules, scenes, and voice control are disabled. When engaged, the flash feature generates in-app push notifications. When an emergency button is pressed and released a connected load begins a flash sequence, which may include a three time half-second flash on with a half-second delay between, then a one-second pause, then repeat.

Embodiments of the device may first require selection in a setting. The device may activate the emergency flashing mode through a press and hold off to off position for five seconds. The mode is deactivated by a secondary press and hold off position for five seconds. LED illumination within the in wall unit may duplicate the load flash sequence when the emergency flash is active. Color change light bulb features may generate the same flash sequence as well as color change. For example, the flash sequence may illuminate red for fire and security emergencies or blue for ambulance or medical emergencies.

Although the present invention has been described in relation to particular embodiments thereof, many other variations and modifications will become apparent to those skilled in the art. It is preferred, therefore, that the present invention be limited not by the specific disclosure herein, but only by the appended claims. Alternate embodiments may be devised without departing from the spirit or scope of the invention. Further, the particular feature or structure may be combined in any suitable manner in one or more embodiments.

What is claimed is:

1. An emergency flash switch device, comprising:
a housing;
a line;
a load;
a neutral;
a power converter;
a timing and control circuit;
a switching mechanism;
an on button;
an on switch;
whereas the on switch is configured to close when the on button is pressed, and the timing and control circuit is configured to apply a signal of correct state to activate the switching mechanism and close a circuit between the line and the load which supplies power to at least one electrically connected lighting device;
an off button;
an off switch;
whereas the off switch is configured to close when the off button is pressed, and the timing and control circuit is configured to apply a signal of correct state to deactivate the switching mechanism and open the circuit between the line and the load which removes power to at least one electrically connected lighting device;
an emergency sequence activator button;
an emergency sequence activator switch; and
whereas the emergency sequence activator switch is configured to close when the emergency sequence activator button is pressed, and the timing and control circuit is configured to apply an alternating signal to the switching mechanism which alternately closes and opens a connection between the line and the load which supplies and removes power to the at least one electrically connected lighting device in response to the alternating signal.

2. The device of claim 1, further comprising:
whereas when the emergency sequence activator switch is closed, the timing and control circuit is configured to apply a continuous alternating signal to the switching mechanism which alternately closes and opens a connection between the line and the load which supplies and removes power to the at least one electrically connected lighting device in response to the alternating signal when the on switch is in a closed or open position or when the off switch is in a closed or open position.

3. The device of claim 1, further comprising:
whereas the emergency sequence activator switch closes when the emergency sequence activator button is pressed, and the timing and control circuit is configured to apply an alternating signal with a prescribed sequence and a prescribed repetition to the switching mechanism which alternately closes and opens a connection between the line and the load which supplies and removes power to the at least one electrically connected lighting device in response to the alternating signal.

4. The device of claim 1, further comprising:
at least one sensor;
whereas the at least one sensor is configured to detect an emergency; and
whereas the at least one sensor is configured to detect at least one of the following: a water leak, a reduced level of air quality, radon, smoke, a door positional change, a window positional change, or motion in an area.

5. The device of claim 1, further comprising:
the emergency flash switch device is configured to send a push notification to alert authorities of an emergency when the emergency switch activator switch closes.

6. The device of claim 1, further comprising:
a color change feature whereas the lighting device changes color;
whereas the device is connected to a wireless network; and
whereas the color change feature is configured to be initiated by the emergency sequence activator switch.

7. The device of claim 1, further comprising:
whereas the emergency sequence activator switch is configured to be closed by initiation through receiving command from one of the following: a smart phone, a personal computer, a laptop, or a wireless remote.

8. The device of claim 1, further comprising:
whereas the device is connected to a wireless network;
a bulb;
whereas at least one of a prescribed sequence, a prescribed repetition, or a prescribed color is configured to be applied to the bulb through commands received through a wireless network.

9. An emergency flash switch device, comprising:
a housing;
a line;
a load;
a neutral;
a power converter;
a timing and control circuit;
a switching mechanism;
an on button;
an on switch;
whereas the on switch is configured to close when the on button is pressed, and the timing and control circuit is configured to apply a signal of correct state to activate the switching mechanism and close a circuit between the line and the load which supplies power to at least one electrically connected lighting device;
an off button;
an off switch;
whereas the off switch is configured to close when the off button is pressed, and the timing and control circuit is configured to apply a signal of correct state to deactivate the switching mechanism and open the circuit between the line and the load which removes power to at least one electrically connected lighting device; and
an emergency sequence activator switch.

10. The device of claim 9, further comprising:
whereas when the emergency sequence activator switch is configured to be closed, the timing and control circuit is configured to apply a continuous alternating signal to the switching mechanism which alternately closes and opens a connection between the line and the load which supplies and removes power to the at least one electrically connected lighting device in response to the alternating signal when the on switch is in a closed or open position or when the off switch is in a closed or open position.

11. The device of claim 9, further comprising:
whereas the emergency sequence activator switch closes when the off button is pressed and held, and the timing and control circuit is configured to apply an alternating signal with a prescribed sequence and a prescribed repetition to the switching mechanism which alternately closes and opens a connection between the line and the load which supplies and removes power to the at least one electrically connected lighting device in response to the alternating signal.

12. The device of claim 9, further comprising:
at least one sensor;
whereas the at least one sensor is configured to detect an emergency; and
whereas the at least sensor is configured to detect one of the following: a water leak, a reduced level of air quality, radon, smoke, a door positional change, a window positional change, or motion.

13. The device of claim 9, further comprising:
the emergency flash switch device is configured to send a push notification to alert authorities of an emergency when the emergency flash activator switch closes.

14. The device of claim 9, further comprising:
a color change feature whereas the lighting device changes color;
whereas the device is connected to a wireless network; and
whereas the color change feature is configured to be initiated by the emergency sequence activator switch.

15. The device of claim 9, further comprising:
whereas the emergency sequence activator switch is closed by initiation through receiving commands from one of the following: a smart phone, a personal computer, a laptop, or a wireless remote.

16. The device of claim 9, further comprising:
whereas the device is connected to a wireless network;
a bulb;
whereas at least one of a prescribed sequence, a prescribed repetition, or a prescribed color is configured to be applied to the bulb through commands received through a wireless network.
